(19) United States
(12) Patent Application Publication
(10) Pub. No.: US 2021/0260962 A1
(43) Pub. Date: Aug. 26, 2021

(54) HEATING DEVICE FOR HEATING AIR

(71) Applicant: TRUMA GERÄTETECHNIK GMBH & CO. KG, Putzbrunn (DE)

(72) Inventors: Uwe ARMBRUSTER, Putzbrunn (DE); Markus JÄGER, Putzbrunn (DE); Johannes LAGING, Putzbrunn (DE)

(21) Appl. No.: 17/269,170

(22) PCT Filed: Aug. 9, 2019
(86) PCT No.: PCT/EP2019/071407

§ 371 Date: Feb. 17, 2021

(30) Foreign Application Priority Data
Aug. 21, 2018 (DE) 10 2018 006 595.3

(51) Int. Cl. B60H 1/22

(52) U.S. Cl. CPC B60H 1/2225; B60H 2001/2271; B60H 1/2212

(57) ABSTRACT

The invention relates to a heating device for heating air, having a primary heat source (10) and a heat exchanger (2). The heat exchanger (2) has an interior space (22) for receiving the primary heat source (10) and transfers thermal energy generated by the primary heat source (10) to the air. The heat exchanger (2) includes a holding element (21) for receiving an electric heating element (11) as a secondary heat source (2). The heat exchanger (2) consists of a first heat exchanger unit (201) and a second heat exchanger unit (202).

The invention relates to a heating device for heating air. The heating device may be part of a room heating. For example, heating the air serves to warm up or heat a further medium, e.g. service water, so that the air is only an intermediate medium for heat transfer.

In the prior art (cf. WO 92/20975 A1), air heating apparatus are known which have a heat exchanger. The heat exchanger has fins that serve to transfer the thermal energy from the flue gas to the air to be heated. In the heat source used, an air-gas mixture is combusted. Other configurations of heat exchangers are disclosed in DE 199 02 050 A1 or DE 10 2006 025 320 A1.

The aforementioned heating apparatus are employed, for example, in moving spaces as are found in motorhomes, travel trailers or boats.

If it is intended to increase the heating power in such apparatus, it is required, for example, to increase the size of the heat source, which results in an increase in the overall dimensions as well. This, however, is generally unfavorable for moving spaces.

The object on which the invention is based is therefore to propose an improvement of such heating devices, which, for example, also allows the heating power to be increased as simply as possible.

The invention achieves the object by means of a heating device for heating air, including at least one heat source and at least one heat exchanger, the heat exchanger transferring thermal energy generated by the heat source to the air, and the heat exchanger including at least one holding element for receiving an electric heating element.

The heating device thus has a heat exchanger having at least one holding element that is intended to receive an electric heating element. This means that such an electric heating element can be used, for example, to boost the heating power of the heating device by the additionally electrically generated heat.

Depending on the configuration, the heat exchanger is constructed in one part or in multiple parts. In the multi-part variant, there is a mechanical and/or direct thermal contact between the parts of the heat exchanger, or the parts are configured and arranged separately from each other. The multi-part construction is preferably such that the parts essentially have identical or similar shapes.

According to one configuration, the heat exchanger has a plurality of ribs or fins, which in particular extend radially inwards or radially outwards. The fins exhibit the surface area effective for heat transfer. In addition, ducts are formed between the fins, through which the air is guided. Here, in one configuration, the heat exchanger is cylindrical in shape, with the fins extending along the entire length of the outer or inner surface. If the heat exchanger is constructed in multiple parts from a plurality of components, fins of the individual components may be opposite each other or some of them may even touch each other.

One configuration resides in that the holding element is configured to receive a rod-shaped electric heating element. In this configuration, a rod-shaped electric heating element is held by the holding element. In one configuration, the heating element may be rod-shaped only in sections.

One configuration provides that the heat exchanger comprises an interior space for receiving a primary heat source, and that the holding element for receiving the electric heating element serves as a secondary heat source. The primary heat source is, for example, a gas or diesel burner. In one configuration, the heat exchanger surrounds the centrally arranged primary heat source. The electric heating element thus supplements the primary heat source. In one configuration, this is underlined by the fact that the electric heating element and/or the component of the heat exchanger that includes the holding element can be introduced subsequently.

According to a supplementary configuration, the heat exchanger includes a plurality of holding elements, the holding elements being arranged radially spaced around the interior space. The holding elements are thus arranged around the interior space for a primary heat source in such a way that satellites, as it were, are formed for at least one electric heating element or, correspondingly, for a plurality of electric heating elements.

In one configuration, the interior space has an essentially cylindrical contour. The base surface of the cylinder is, for example, a circular surface. Here, in one configuration, fins of the heat exchanger may protrude into the cylindrical interior. Accordingly, in one configuration, the heat exchanger has an elongated and/or cylindrical contour.

The following configurations relate in part to the fact that the heat exchanger is multi-part and consists of at least two parts, units or components. Depending on the design, the units are joined together to form a reversibly connected heat exchanger or are not mechanically contacted with each other. It can be assumed here that all units are at least indirectly thermally contacted via the air as an intermediary.

One configuration resides in that the heating device includes a housing, that the heat exchanger consists of a first heat exchanger unit and at least one second heat exchanger unit, that the housing and the first heat exchanger unit define an air duct for the air to be heated, and that the first heat exchanger unit is arranged within the housing such that at least the second heat exchanger unit is insertable into the air duct.

In this configuration, the heat exchanger consists of at least two heat exchanger units. The first heat exchanger unit is dimensioned and arranged in a housing that surrounds the heat exchanger such that sufficient space remains in the interior of the housing so that the at least one second heat exchanger unit can be introduced into the housing. The second heat exchanger unit is thus introduced into the air duct, which is located between the housing and the first heat exchanger unit and through which the air to be heated flows. Here, in one configuration, the first heat exchanger unit is dimensioned to be larger than the second heat exchanger unit.

One configuration provides that the heat exchanger consists of the first heat exchanger unit and a plurality of second heat exchanger units, and that the first heat exchanger unit is arranged within the housing such that the plurality of second heat exchanger units can be inserted into the air duct, preferably symmetrically to each other.

In this configuration, there is sufficient space in the air duct between the inner wall of the housing and the first heat exchanger unit so that more than one second heat exchanger unit can be inserted. In one configuration, the second heat exchanger units are inserted in particular symmetrically to each other and/or symmetrically to the first heat exchanger unit.

One configuration resides in that the electric heating element, surrounded by an insulation, is pressed into the holding element. This configuration has the effect that the holding elements and the respective electric heating element constitute a common unit. This simplifies manufacturing and handling of the components.

In one configuration, provision is made that the heat exchanger consists of a first heat exchanger unit and at least one second heat exchanger unit, and the first heat exchanger unit and the at least one second heat exchanger unit being free from thermal contact with each other. In this configuration, there is no direct thermal contact between the first and at least one second heat exchanger units. For example, there is a thermal insulation or a sufficiently large distance. In a supplementary configuration, all of the second heat exchanger units, if there are several of them, are also free from a thermal contact (or, alternatively, a thermal coupling).

One configuration resides in that the heat exchanger consists of a first heat exchanger unit and at least one second heat exchanger unit, and in that the first heat exchanger unit and the at least one second heat exchanger unit are in thermal contact with each other. The thermal contact results in a direct thermal coupling, which in one configuration also exists between a plurality or all of the second heat exchanger units.

One configuration provides that the heat exchanger consists of a first heat exchanger unit and at least one second heat exchanger unit, that the second heat exchanger unit concentrically surrounds the first heat exchanger unit, and that fins of the first heat exchanger unit that project radially outwards and fins of the second heat exchanger unit that project radially inwards are configured and arranged such that the fins of the first heat exchanger unit are insertable between the fins of the second heat exchanger unit. In this configuration, the recesses or gaps between the fins of one heat exchanger unit are formed such that the fins of the opposite heat exchanger unit just fit in. This results in an alternation of the different fins over the circumference. Depending on the configuration, the fins of the same heat exchanger unit may also follow one another. This is the case, for example, if the distance between the neighboring fins of one heat exchanger unit is greater than the distance between the neighboring fins of the other heat exchanger unit.

One configuration resides in that the heat exchanger consists of a first heat exchanger unit and at least one second heat exchanger unit, and that the first heat exchanger unit and the second heat exchanger unit include contact profiles corresponding to each other for a releasable mechanical and/or direct thermal connection. The corresponding contact profiles, each matching the other, allow an increased stability, a reliable connection or a simplified production.

One configuration provides that the heat exchanger consists of a first heat exchanger unit and at least one second heat exchanger unit, and that at least one holding element is formed by the first heat exchanger unit and the second heat exchanger unit. In this configuration, the first heat exchanger unit and at least one second heat exchanger unit have substructures of a holding element which complement each other to form a holding element.

One configuration resides in that the heat exchanger consists of a first heat exchanger unit and at least one second heat exchanger unit, and that the first heat exchanger unit and the at least one second heat exchanger unit are releasably connected to each other. In this configuration, there is a reversible connection between the heat exchanger units. Alternatively, a first heat exchanger unit and at least one second heat exchanger unit are irreversibly connected to each other.

One configuration provides that at least one placeholder is provided and that the placeholder is insertable into the holding element instead of the electric heating element. Owing to the placeholder, a flow of air is obtained, for example, which corresponds to that when the heating element is inserted. Therefore, for example, a structure for guiding the air can be optimized. Furthermore, the same weight distribution can also be achieved.

One configuration resides in that at least two holding elements are provided and in that a bent electric heating element is held by the at least two holding elements. In this configuration, one heating element is held by a plurality of holding elements. This is based on the fact that the heating element has an appropriately curved profile so that the heating element can pass through a plurality of holding elements.

In one configuration, it is provided that the at least one holding element has an annular shape that opens at least on one side, and that the holding element has an elastic widening of the opening for receiving the electric heating element. In this configuration, the holding element is constructed such that the heating element can be clipped in, as it were. This simplifies the manufacturing or also the subsequent introduction of the heating element for a heating device that has already been installed, for example.

One configuration resides in that the heating device is configured for use in a moving space, in particular in a travel trailer or a motorhome.

One configuration provides that the heat exchanger is an extruded part, at least in part. The construction in the form of an extruded part reduces costs and also results in very reproducible components.

Generally, the special heat exchanger allows an electric heating element to be introduced even at a later date. In addition, the holding element also simplifies the manufacture of a heating device which features, for example, a gas or diesel burner and at least one electric heating element.

In detail, there are a multitude of possibilities of configuring and further developing the heating device according to the invention. In this regard, reference is made, for one thing, to the claims dependent on claim 1 and, for another, to the following description of exemplary embodiments in conjunction with the drawings, in which:

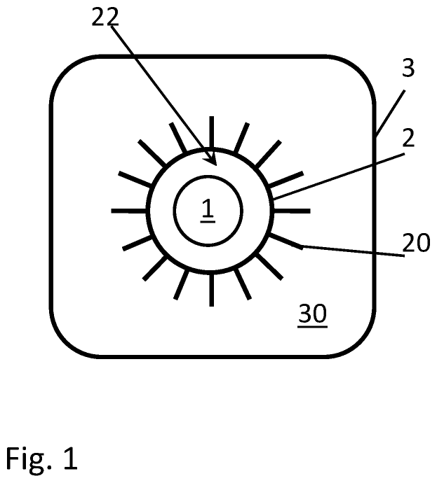

FIG. 1 shows a schematic representation of a heating device according to the prior art,

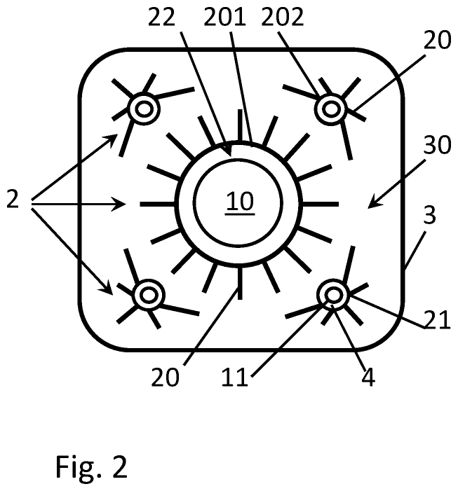

FIG. 2 shows a section through a schematic representation of a first configuration of a heating device according to the invention,

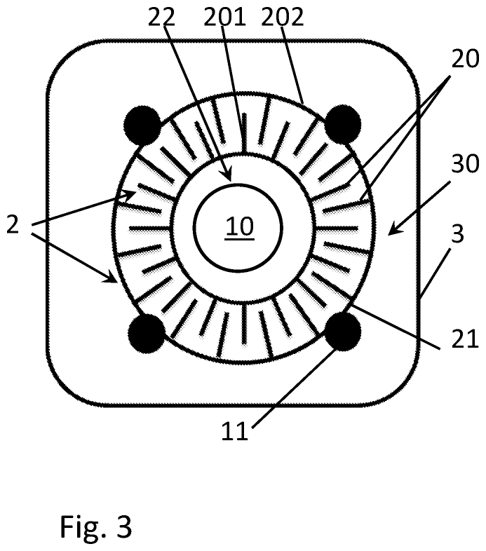

FIG. 3 shows a section through a schematic representation of a second configuration of a heating device according to the invention,

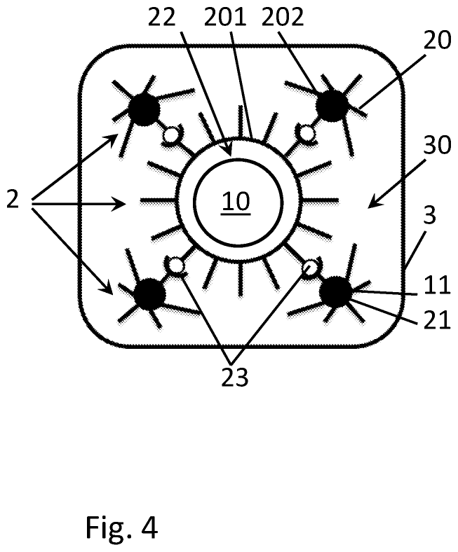

FIG. 4 shows a section through a schematic representation of a third configuration of a heating device according to the invention,

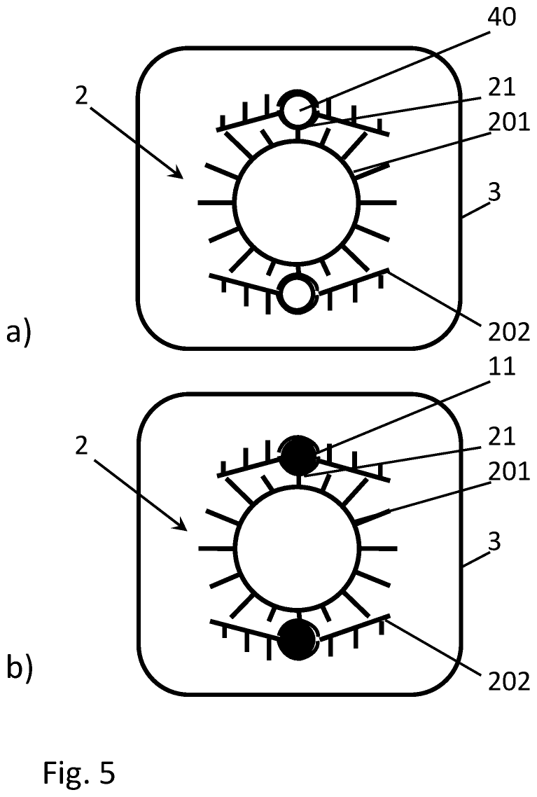

FIGS. 5 a) and b) show a section through a schematic representation of a fourth configuration of a heating device according to the invention in two different component placement states,

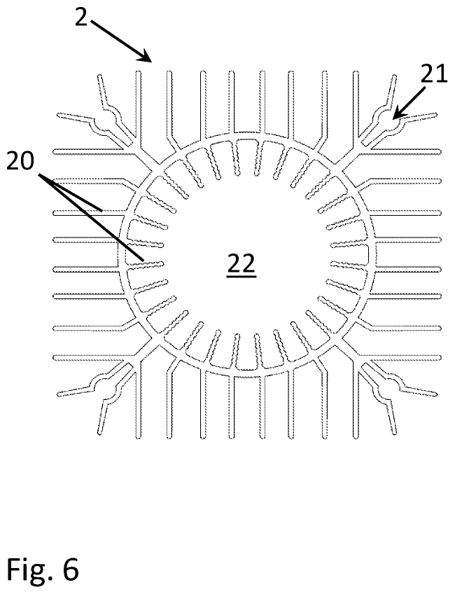

FIG. 6 shows a section through a first configuration of a heat exchanger according to the invention,

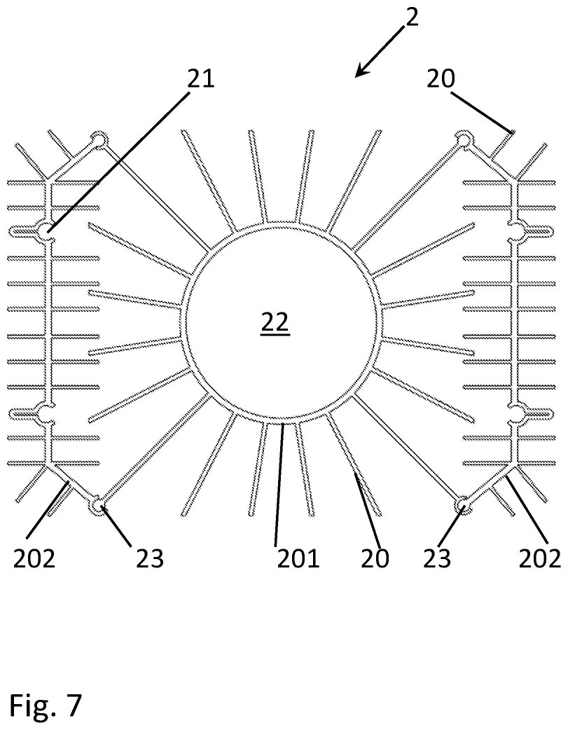

FIG. 7 shows a section through a second configuration of a heat exchanger according to the invention, and

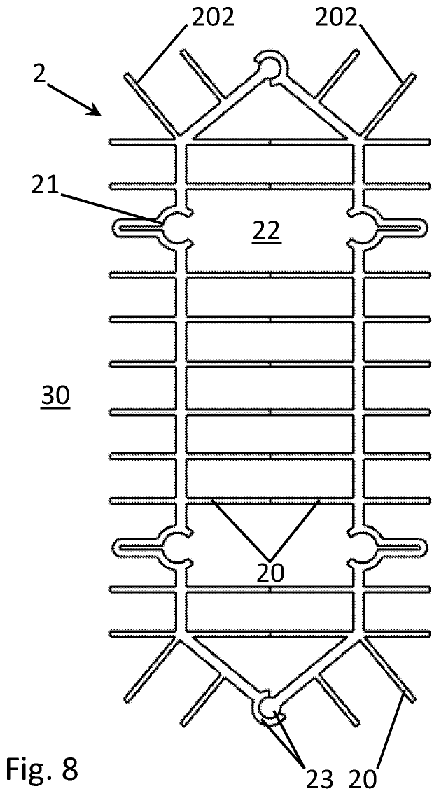

FIG. 8 shows a section through a third configuration of a heat exchanger according to the invention.

FIG. 1 shows a section through a schematic heating device according to the prior art.

The heat source 1 is formed by a combustion chamber in which an air-gas mixture is combusted. The combustion gases produced in the process are discharged through a heating chamber and then through an exhaust system (not illustrated here).

The substantially cylindrical heat source 1 is surrounded by a heat exchanger 2. To this end, the heat exchanger 2 comprises an interior space 22, which serves to accommodate the heat source 1. The heat exchanger 2 transfers the thermal energy of the heat source 1, or more specifically of the combustion or flue gases, to air which is conveyed along the outside of the heat exchanger 2, e.g. by means of a fan (not illustrated here). On its outside, the heat exchanger 2 features a plurality of ribs or fins 20, which increase the surface area that is effective for the transfer of heat and between which ducts for the air are formed.

The heat exchanger 2 is surrounded by a housing 3, which also co-defines the air duct 30 through which the air is guided around the heat exchanger 2.

The following Figures each show a section through a heating device according to the invention. For the sake of clarity, the illustration is greatly simplified. For example, only the respective outside of the various heat exchangers 2 is shown and described. Depending on the embodiment, however, fins protruding inwards may also be present, for example, or the fins—protruding inwards or outwards—may exhibit specially designed surfaces or contours.

FIG. 2 shows a section through a schematic representation of a first configuration of the heating device according to the invention. Generally, the heat exchanger 2 has an oblong or cylindrical extent.

Located within the housing 3 is a heat exchanger 2, which in this case consists of a total of five heat exchanger units 201, 202: These are one first heat exchanger unit 201 and four second heat exchanger units 202.

The first heat exchanger unit 201 has an interior space 22 which comprises a primary heat source 10 in the form of a gas burner according to the prior art. This therefore corresponds to the configuration as illustrated and described with reference to FIG. 1.

Located between the first heat exchanger unit 201 and the inner wall of the surrounding housing 3 is an air duct 30 through which the air to be heated is passed.

The four second heat exchanger units 202 are provided for supplementing the primary heat source 10 by the secondary heat sources 11 in the form of heating rods, which are four in the illustrated embodiment. Alternatively, e.g., two, six, eight, and so on secondary heat sources 11 are provided. Integer multiples of two are favored for a symmetrical structure and/or a symmetrical heat distribution. The four second heat exchanger units 202 are inserted in the air duct 30 around the first heat exchanger unit 202 such that they fill the gaps, so to speak, between the first heat exchanger unit 201 and the inner wall of the housing 3. In the illustrated configuration, this insertion is simplified in that the housing 3 encompasses a rectangular interior space and in that the first heat exchanger unit 201 together with its fins 20 defines a circular cross-section.

The first heat exchanger unit 201 and the second heat exchanger units 202 as well as the second heat exchanger units 202 among each other here are free from thermal contact with each other, so that in the illustrated embodiment no thermal energy transfer occurs between or among the heat exchanger units 201, 202 themselves.

The second heat exchanger units 202 each have five fins 20 and an annular holding element 21. The air to be heated can circulate between the fins 20 of the second heat exchanger units 202. In addition, these fins 20 enlarge the interaction surface area. The electric heating elements 11 in the holding elements 21 are each surrounded by a thermally conductive insulation 4. In one configuration, the electric heating elements 11, for example a heating coil, and the insulation 4 are connected by a suitable pressing tool to form a finished unit. In an alternative configuration, the heating element 11 is placed in the holding element 21 without insulation.

In one configuration, instead of two separate electric heating elements 11, a heating rod bent in a U-shape is used, onto which two respective second heat exchanger units 202 are slid.

The second heat exchanger units 202 are introduced here along with the electric heating elements 11 after the first heat exchanger unit 201, thus allowing the heating power to be increased.

In the configuration of FIG. 3, a first heat exchanger unit 201 and a second heat exchanger unit 202 are provided as parts of the heat exchanger 2.

The two heat exchanger units 201, 202 each include a circular-cylindrical base body which, in section, appears as a ring. The second heat exchanger unit 202 coaxially surrounds the first heat exchanger unit 201 here. Inside the first heat exchanger unit 201 there still exists the interior space 22 for the primary heat source 10.

Arranged on the base body of the second heat exchanger unit 202, which thus functions as a holding element 21, there are four (in alternative configurations: any other number) electric heating elements 11, which are distributed symmetrically on the circumference.

The first heat exchanger unit 201, located inside, includes fins 20 that extend radially outward. The encompassing second heat exchanger unit 202 also features fins 20 that extend radially inward and thus toward the first heat exchanger unit 201. The distances between the fins 20 of the first heat exchanger unit 201 and between the fins 20 of the second heat exchanger unit 202 are each dimensioned such that the fins of the second heat exchanger unit 202 can be inserted between the fins 20 of the first heat exchanger unit 201. In this way, a direct mechanical contact between the fins 20 is avoided, and the two heat exchanger units 201, 202 can be slid into each other during manufacturing or subsequent component mounting.

The air duct 30 for the air to be heated is thus defined by the space between the second heat exchanger unit 202 and the inner wall of the housing 3 and by the space between the fins 20 of the first heat exchanger unit 201 and the second heat exchanger unit 202.

The configuration of FIG. 4 is similar to the configuration of FIG. 2.

Common to both configurations is that there is a first heat exchanger unit 201 with the interior space 22 for a primary heat source 10 and four second heat exchanger units 201 for an electric heating element 11 each. The first heat exchanger unit 201 and the four second heat exchanger units 202 together constitute the heat exchanger 2 inside the housing 3 and surrounded by the air duct 30 for the air to be heated. For the sake of clarity, the second heat exchanger units 202—specifically the holding elements 21—and the electric heating elements 11 are shown in one piece here.

The addition to the configuration of FIG. 4 consists in the mechanical and preferably also thermally conductive connection between the first heat exchanger unit 201 and the four second heat exchanger units 202. This connection or direct coupling takes place here via mutually corresponding contact profiles 23, which are applied onto the fins 20 of the first heat exchanger unit 201 or those of the second heat exchanger units 202. The fins 20 in question each have contours on the face side which can be introduced into corresponding mating contours. Here, combinations of profiles (ball shape) and associated negative profiles (half shells with corresponding inside diameters) are shown.

The second heat exchanger units 202 thus generate satellite-like continuations of the first heat exchanger unit 201 here by way of the contact profiles 23.

In the configuration of FIG. 5, one first heat exchanger unit 201 and two second heat exchanger units 202 are provided. The three heat exchanger units 201, 202 thus form the heat exchanger 2 within the housing 3.

The two second heat exchanger units 202 have a fin structure such that they largely encompass the first heat exchanger unit 201 laterally. The two second heat exchanger units 202 are opposite each other here.

The holding elements 21 are arranged centrally in the second heat exchanger units 202 and are formed jointly by the first heat exchanger unit 201 and the second heat exchanger units 202. The contact profiles 23 within the meaning of the configuration of FIG. 4 are thus realized here by the shared holding elements 21.

FIG. 5 a) illustrates the case in which the second heat exchanger units 202 are connected to the first heat exchanger unit 201 and they jointly form the heat exchanger 2, but located within the holding elements 21 are only placeholders 40 for the electric heating elements 11 proper.

In FIG. 5 b), the electric heating elements 11 are inserted instead of the placeholders 40.

In this configuration, the placeholders 40 serve to make sure that the same internal geometry and also the same weight distributions are given in the heating device with and without the heating element 11. Thus, for example, the same flow behavior of the air is produced inside the housing 3 in each case.

FIG. 6 illustrates a one-piece heat exchanger 2.

Fins 20, which are corrugated here, project into the interior space 22 and, starting from the ring of the heat exchanger 2, further fins 20 extend radially outward. The heat exchanger 2 has a rectangular outer contour due to the dimensions of the fins 20.

Four of the fins 20 have a respective holding element 21 which allows an electric heating element to be placed therein.

The holding element 21 is substantially ring-shaped here and has an opening directed radially outward. The edges of the opening flare radially. In this case, the dimensions of the holding elements 21 and the nature or quality of the fins concerned are selected and adapted to each other such that the heating element can be inserted laterally during manufacture and that the holding element 21 expands elastically when an appropriate pressure is applied. In this way, the heating element is received and subsequently securely held.

FIG. 7 shows a heat exchanger 2 which, similar to the configuration of FIG. 5, consists of one first heat exchanger unit 201 and two second heat exchanger units 202.

The two second heat exchanger units 202 are located opposite each other, thus flanking the first heat exchanger unit 201, and have an oblong extent. In addition, here the second heat exchanger units 202 each have two holding elements 21.

As in the other configurations, the first heat exchanger unit 201 is essentially of a circular cylindrical design so that, in section, a ring shape is obtained. The ring encompasses the interior space 22. Fins 20 extend radially outwards, with four fins 20 having a respective contact profile 23 on the face side.

The two second heat exchanger units 202 feature corresponding contact profiles 23 at their end portions, so that a respective mechanical contact can be produced between the first heat exchanger unit 201 and the second heat exchanger units 202. In this case, the contact profiles 23 consist of balls and half shells.

The second heat exchanger units 202 also have fins 20, some of which are directed towards the first heat exchanger unit 201 and some of which are directed away from it.

FIG. 8 shows the second heat exchanger units 202 of FIG. 7, which are directly connected to each other, jointly constituting the heat exchanger 2.

This variant is made possible by the contact profiles 23, which are constructed such that they can be connected not only with the first heat exchanger unit, but also with each other. Therefore, the two ends of the second heat exchanger units 202 also differ with respect to the shape of the contact profiles 23.

The two second heat exchanger units 202 enclose an interior space 22; the air to be heated can flow through the interior space 22 as well as through the outer air duct 30. The fins 20 which project inwards and, in the configuration shown, are in direct contact with one another, reach through the interior space 22 here.

The four holding elements 21 allow the insertion of up to four electric heating elements, which in this configuration thus form the primary and single heat source.

### LIST OF REFERENCE NUMBERS

1 heat source
2 heat exchanger
3 housing
4 insulation
10 primary heat source
11 electric heating element
20 fin
21 holding element
22 interior space
23 contact profile
30 air duct
40 placeholder
201 first heat exchanger unit
202 second heat exchanger unit

1. (canceled)

2. (canceled)

3. (canceled)

4. (canceled)

5. (canceled)

6. (canceled)

7. (canceled)

8. (canceled)

9. (canceled)

10. (canceled)

11. A heating device for heating air,
comprising a primary heat source (10), a heat exchanger (2) and a housing (3),
wherein the heating device is configured for use in a travel trailer or a motorhome,
wherein the primary heat source (10) is a gas or diesel burner,
wherein the heat exchanger (2) surrounds the centrally arranged primary heat source (10),
wherein the heat exchanger (2) comprises an interior space (22) for receiving the primary heat source (10) and transfers thermal energy generated by the primary heat source (10) to the air, and
wherein the heat exchanger (2) includes a plurality of holding elements (21) that are radially spaced apart, arranged around the interior space (22), and serve to receive a respective electric heating element (11) as a secondary heat source (2),
characterized in that
the heat exchanger (2) consists of a first heat exchanger unit (201) and a plurality of second heat exchanger units (202), each for a respective electric heating element (11),
in that the first heat exchanger unit (201) and the second heat exchanger units (202) include contact profiles (23) corresponding to each other for a releasable mechanical and/or direct thermal connection,
in that the housing (3) and the first heat exchanger unit (201) define an air duct (30) for the air to be heated, and
in that the first heat exchanger unit (201) is arranged within the housing (3) such that the plurality of second heat exchanger units (202) are insertable into the air duct (30) so as to be symmetrical to each other.

12. The heating device according to claim 1,
wherein at least one placeholder (40) is provided, and
wherein the placeholder (40) is insertable into the holding element (21) instead of the electric heating element (11).

13. The heating device according to claim 1,
wherein the at least one holding element (21) has an annular shape that opens at least on one side, and
wherein the holding element (21) has an elastic widening of the opening for receiving the electric heating element (11).

14. The heating device according to claim 1,
wherein the electric heating element (11), surrounded by a thermally conductive insulation (4), is pressed into the holding element (21).
